(19) United States
(12) Patent Application Publication
(10) Pub. No.: US 2006/0158545 A1
(43) Pub. Date: Jul. 20, 2006

(54) Image display method, imaging method, and image synthesis method

(76) Inventor: Makoto Hirai, Osaka (JP)

Correspondence Address: MCDERMOTT WILL & EMERY LLP, 600 13TH STREET, N.W., WASHINGTON, DC, 20005-3096, US

(21) Appl. No.: 11/333,350

(22) Filed: Jan. 18, 2006

(30) Foreign Application Priority Data
Jan. 19, 2005 (JP) 2005-011899

(51) Int. Cl. H04N 5/222

(52) U.S. Cl. 348/333.01

(57) ABSTRACT

An image display method according to the present invention includes the step of detecting a displacement of a display device; and the step of shifting an image on the display device by subpixel units in a direction opposite to the displacement of the display device to an extent corresponding to the displacement of the display device and displaying the shifted image.

### BACKGROUND OF THE INVENTION

The present invention relates to techniques for taking or displaying images, and more particularly relates to techniques for improving the quality of images which are taken or displayed.

In a hand-held apparatus for taking or displaying images, correction of hand-shake is critical. For example, the Japanese Laid-Open Publication No. 2002-123242 discloses a technique in which a displacement of a display device resulting from shifting of the display device is detected and the image display position on the display device is shifted in the direction opposite to the displacement. Also, the Japanese Laid-Open Publication No. 7-283999 discloses a technique in which an image having a higher number of pixels than an imaging device is obtained by using less-than-pixel-size shifting of the imaging device.

However, in light of image quality, complete correction of hand-shake does not always provides the highest image quality; there are cases in which a more desirable quality image can be recorded, transmitted, and displayed when a proper amount of hand-shake is left. This is because when a human sees a series of images obtained by utilizing less-than-pixel-size shifting of an imaging device, his brain estimates values of pixels smaller than the pixels of the imaging device and is thus capable of recognizing those images as high-resolution images. Therefore, from the viewpoint of image quality improvement, there has been a demand for a hand-shake correction method, in which less-than-pixel-size correction of hand-shake, i.e., hand-shake correction by subpixel units, is performed.

Furthermore, the aforementioned Japanese Laid-Open Publication No. 7-283999 discloses a method in which pixel values taken when an imaging device is at a position shifted by less than the pixel size are used as the pixel values of the corresponding positions in the output image that has a higher number of pixels than the imaging device. However, if the pixel values of the imaging device are used as they are, a significant improvement of the image quality cannot be expected. Therefore, there has been a demand for an imaging method in which pixel values for a digital image are accurately estimated by subpixel units.

### SUMMARY OF THE INVENTION

An object of the present invention is to display an image in such a manner that the image is recognized as a high-resolution image that has a higher number of pixels than the display device.

Another object of the present invention is to take an image that contains more information than an image having the same number of pixels as the imaging device.

Specifically, a first method for displaying an image according to the present invention includes: the step of detecting a displacement of a display device; and the step of shifting an image on the display device by subpixel units in a direction opposite to the displacement of the display device to an extent corresponding to the displacement of the display device and displaying the shifted image.

According to the first inventive image display method, pixels are displayed at more points as compared with a case in which the display device is fixed. Therefore, the image can be displayed so as to be recognized as a high-resolution image having a higher resolution than the display device.

A second image display method according to the present invention is a method for displaying an image by a projection-type image display apparatus. The inventive method includes: the step of shifting a region onto which an image can be projected by subpixel units according to a certain pattern; the step of obtaining an image by interpolation each time the region is shifted, so that the image is shifted in a direction opposite to a displacement of the region to an extent corresponding to the displacement; and the step of projecting the obtained image.

According to the second inventive image display method, since the positions of the projected pixels are shifted by subpixel units, a high-resolution image can be displayed by the projection-type image display apparatus.

A third image display method according to the present invention is a method for displaying an image by a projection-type image display apparatus. The inventive method includes: the step of detecting a displacement of a region onto which an image can be projected, in accordance with movement of the image display apparatus; and the step of shifting by subpixel units the image projected onto the region, in a direction opposite to the displacement of the region to an extent corresponding to the displacement of the region and displaying the shifted image.

According to the third inventive image display method, pixels are displayed at more points as compared with a case in which the image display apparatus is fixed. Therefore, the image can be displayed so as to be recognized as a high-resolution image having a higher resolution than the display device.

A fourth method for displaying an image according to the present invention includes: the step of taking a plurality of images with an incident image on an imaging device being shifted by subpixel units according to a certain pattern; the step of detecting a displacement of a display device; and the step of selecting, from the plurality of images, an image which is obtained by shifting an image on the display device in a direction opposite to the displacement of the display device to an extent corresponding to the displacement of the display device and displaying the selected image.

According to the fourth inventive image display method, an image can be displayed so as to be recognized as a high-resolution image having a higher resolution than the display device, without obtaining the image by interpolation.

A fifth inventive method for displaying an image according to the present invention includes: the step of taking a plurality of images with an incident image on an imaging device being shifted by subpixel units according to a certain pattern; and the step of estimating pixel values based on the plurality of images and respective displacements of the plurality of images, estimating based on the estimated pixel values an image which has a higher number of pixels than the plurality of images, and displaying the estimated image.

According to the fifth inventive image display method, it is possible to estimate that number of pixel values corresponding to the number of taken images, thereby estimating and displaying a high-resolution image.

A first method for taking an image according to the present invention includes: the step of taking a first image by an imaging device; the step of shifting an incident image on the imaging device by subpixel units according to a certain pattern; the step of taking the shifted incident image as a second image; and the step of estimating pixel values based on the first and second images and a displacement of the second image with respect to the first image, thereby estimating a third image which has a higher number of pixels than the first and second images.

According to this method, an incident image shifted by subpixel units is taken to estimate pixel values, whereby it is possible to obtain an image which has a higher number of pixels than the imaging device.

A second method for taking an image according to the present invention includes: the step of taking a first image by an imaging device; the step of taking a second image after an incident image on the imaging device is shifted; the step of detecting a displacement of the second image with respect to the first image, the step of dividing the displacement of the second image into a pixel-unit displacement and a remaining less-than-single-pixel displacement; the step of shifting the second image in a direction opposite to the pixel-unit displacement to an extent equal to the pixel-unit displacement; and the step of estimating pixel values based on the first image, the shifted second image, and the less-than-single-pixel displacement, thereby estimating a third image which has a higher number of pixels than the first image and the shifted second image.

According to this method, incident light is captured at more points as compared with a case in which the imaging device is fixed. Therefore, an image which has a higher number of pixels than the imaging device can be obtained.

A third method for taking an image according to the present invention includes: the step of detecting movement of an imaging device; the step of adding movement of a certain pattern to the movement of the imaging device; the step of displacing an incident image on the imaging device so that an effect produced by the movement obtained by the addition is canceled; and the step of taking the incident image.

According to this method, it is possible to take an image in which hand-shake is cancelled while the intended blurring caused by the movement of the certain pattern is contained.

A method for synthesizing an image according to the present invention includes: the step of dividing a displacement of a second image with respect to a first image into a pixel-unit displacement and a remaining less-than-single-pixel displacement; the step of shifting the second image in a direction opposite to the pixel-unit displacement to an extent equal to the pixel-unit displacement; and the step of estimating pixel values based on the first image, the shifted second image, and the less-than-single-pixel displacement, thereby estimating a third image which has a higher number of pixels than the first image and the shifted second image.

As described above, according to the present invention, it is possible to take a high-resolution image which has a higher number of pixels than the imaging device, and it is possible to display an image so that the image is recognized as a high-resolution image which has a higher number of pixels than the display device.

### BRIEF DESCRIPTION OF THE DRAWINGS

FIG. 1 is a block diagram of an image taking and display system according to a first embodiment of the present invention.

FIGS. 2A and 2B are explanatory diagrams each showing an example of temporal changes of a displacement based on a certain pattern.

FIG. 3 is a conceptual view showing the relation between incident rays forming an incident image and the output of an imaging device when the pixels on the imaging device are shifted by subpixel units.

FIG. 4 is a block diagram of an image taking and display system according to a second embodiment of the present invention.

### DETAILED DESCRIPTION OF THE INVENTION

Hereinafter, preferred embodiments of the present invention will be described with reference to the accompanying drawings.

### FIRST EMBODIMENT

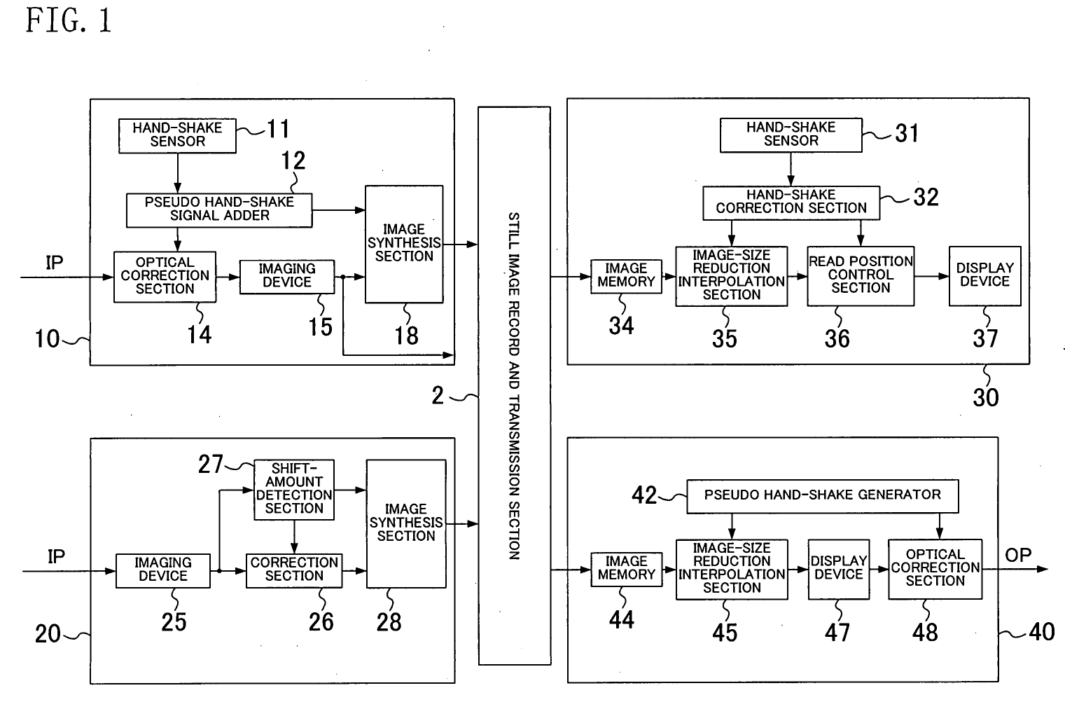

FIG. 1 is a block diagram of an image taking and display system according to a first embodiment of the present invention. The image taking and display system of FIG. 1 includes imaging apparatuses 10 and 20, an image display apparatus 30, a liquid crystal projector 40 serving as a projection-type image display apparatus, and a still image record and transmission section 2. The imaging apparatuses 10 and 20, the image display apparatus 30, and the liquid crystal projector 40 are each capable of operating independently. The purpose of this image taking and display system is to take and display still images.

The imaging apparatus 10 includes a hand-shake sensor 11, a pseudo hand-shake signal adder 12, an optical correction section 14, an imaging device 15, and an image synthesis section 18.

The optical correction section 14 optically controls an incident image IP in accordance with a correction signal and shifts the image on the imaging device 15. The optical correction section 14 is an active prism, for example. The imaging device 15, which is a CCD (Charge-Coupled Device) or a CMOS (Complementary Metal Oxide Semiconductor) sensor, for example, takes the incident image IP and outputs the obtained image to the image synthesis section 18.

The hand-shake sensor 11 senses acceleration, angular acceleration, and the like given to the imaging device 15 by hand-shake, obtains a displacement of the incident image IP on the imaging device 15 caused by the hand-shake, and outputs the obtained displacement to the pseudo hand-shake signal adder 12.

The pseudo hand-shake signal adder 12 adds a displacement based on a certain pattern to the displacement of the incident image IP and outputs the resultant displacement obtained after the addition to the optical correction section 14. The pseudo hand-shake signal adder 12 also outputs the added displacement based on the certain pattern to the image synthesis section 18. The optical correction section 14 shifts the incident image IP in the direction opposite to the displacement obtained after the addition to the same extent as the displacement obtained after the addition.

When an image is taken with the imaging apparatus 10 being hand-held, the hand-shake sensor 11 senses movement of the imaging device 15, and the pseudo hand-shake signal adder 12 adds, to a signal indicating the movement of the imaging device 15, a signal indicating movement caused by a pseudo hand-shake based on a certain pattern. Furthermore, the optical correction section 14 displaces the incident image IP on the imaging device 15 so that the effect of the movement obtained after the addition is cancelled, and the imaging device 15 takes the incident image IP. The imaging device 15 outputs the taken image to the still image record and transmission section 2.

In this case, in the taken image, the hand-shake has been therefore cancelled and the blurring caused by the movement of the certain pattern is contained. In other words, only the intended blurring is contained in the image.

The pseudo hand-shake signal adder 12 may be designed so that it stores, as pseudo hand-shake patterns, a plurality of hand-shake patterns (such as a natural hand-shake of a person who is good at taking images and a hand-shake which contains pseudo reproduction of imaging techniques of a famous photographer), selects one pattern from the stored patterns in accordance with the image-taking situation and the imaging object, and adds movement according to the selected pattern.

The following description will be made based on the assumption that the imaging apparatus 10 is fixed and that the pseudo hand-shake signal adder 12 outputs only a displacement (a pseudo hand-shake) based on a certain pattern to the optical correction section 14.

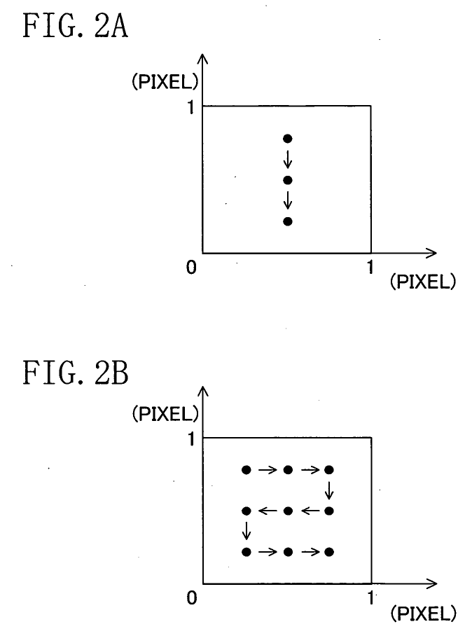

FIGS. 2A and 2B are explanatory diagrams each showing an example of temporal changes of a displacement based on a certain pattern. The pseudo hand-shake signal adder 12 changes a displacement according to a certain pattern as shown in FIG. 2A or 2B and shifts the incident image on the imaging device 15 by subpixel units. “Shifting by subpixel units” means shifting the image with a precision finer than a single pixel. In this embodiment, it is assumed that each component of a displacement is less than a single pixel.

The imaging device 15 takes an incident image corresponding to the first displacement of a pattern. Then, the process, in which the pseudo hand-shake signal adder 12 changes the displacement and the imaging device 15 takes the incident image shifted by the optical correction section 14, is repeated. That is, each time the displacement given by the pseudo hand-shake signal adder 12 is changed, the imaging device 15 takes a different image. The imaging device 15 outputs the taken images to the image synthesis section 18. The pseudo hand-shake signal adder 12 may store a plurality of these patterns, select one from the stored patterns according to the image-taking situation and the imaging object, and add a displacement according to the selected pattern.

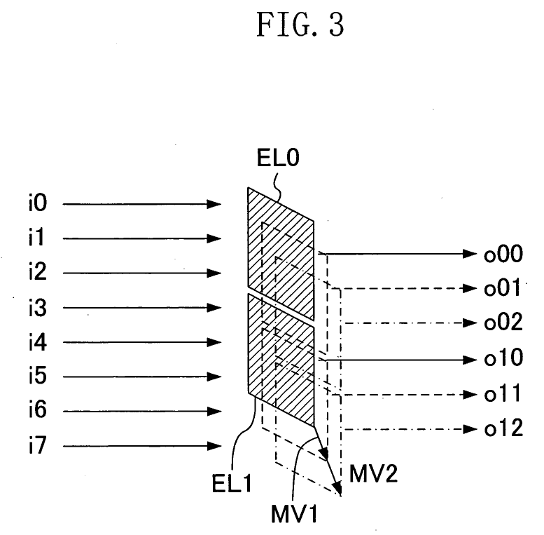

FIG. 3 is a conceptual view showing the relation between incident rays forming an incident image and the imaging device output when the pixels on the imaging device 15 are shifted by subpixel units. In FIG. 3, the spacing between adjacent ones of the incident rays i0, i1, i2, i3, i4, i5, i6, and i7 is one third of the spacing between adjacent pixels in the imaging device 15.

Before the incident image on the imaging device 15 is shifted, the incident rays i0 through i2 are incident onto a pixel EL0. The relation between these incident rays and the output signal o00 can be expressed by the first equation of the following equations (1).

$$\begin{matrix}o 00 = a 0 \times i 0 + a 1 \times i 1 + a 2 \times i 2 \\ o 10 = a 0 \times i 3 + a 1 \times i 4 + a 2 \times i 5\end{matrix} \} \qquad ( 1 )$$

The coefficients a0, a1, and a2 in the equations (1) can be obtained by measuring beforehand the relation between the already known incident rays i0 through i2 and the output signal o00.

Next, a case where the image on the imaging device 15 is shifted will be considered. For the sake of convenience, this case will be considered based on FIG. 3, in which not the incident rays but the imaging device 15 is shifted by a displacement MV1. In this case, the incident rays i1 through i3 are incident onto the pixel EL0, and the relation between these incident rays and the output signal o01 can be expressed by the first equation of the following equations (2).

$$\begin{matrix}o 01 = a 11 \times i 1 + a 21 \times i 2 + a 31 \times i 3 \\ o 11 = a 11 \times i 4 + a 21 \times i 5 + a 31 \times i 6\end{matrix} \} \qquad ( 2 )$$

The coefficients a11, a21, and a31 in the equations (2) can be obtained by measuring beforehand the relation between the already known incident rays i1 through i3 and the output signal o01.

Next, a case where the image on the imaging device 15 is further shifted will be considered. For the sake of convenience, this case will be considered based on the figure, in which not the incident rays but the imaging device 15 is further shifted by a displacement MV2. In this case, the incident rays i2 through i4 are incident onto the pixel EL0, and the relation between these incident rays and the output signal o02 can be expressed by the first equation of the following equations (3).

$$\begin{matrix}o 02 = a 22 \times i 2 + a 32 \times i 3 + a 42 \times i4 \\ o 12 = a 22 \times i 5 + a 32 \times i 6 + a 42 \times i 7\end{matrix} \} \qquad ( 3 )$$

The coefficients a22, a32, and a42 in the equations (3) can be obtained by measuring beforehand the relation between the already known incident rays i2 through i4 and the output signal o02. For a pixel EL1, the relations between the incident rays i3 through i7 and the output signals o10, o11 and o12 can be expressed similarly by equations such as the equations (1) through (3).

The equations (1) through (3) can be summarized as follows.

$$A ( \begin{matrix}i 0 \\ i 1 \\ i 2 \\ i 3 \\ i 4 \\ i 5 \\ i 6 \\ i 7\end{matrix} ) = ( \begin{matrix}o 00 \\ o 01 \\ o 02 \\ o 10 \\ o 11 \\ o 12\end{matrix} ) \\ A = ( \begin{matrix}a 0 & a 1 & a 2 & & & & & \\ & a 11 & a 21 & a 31 & & & & \\ & & a 22 & a 32 & a 42 & & & \\ & & & a 0 & a 1 & a 2 & & \\ & & & & a 11 & a 21 & a 31 & \\ & & & & & a 22 & a 32 & a 42\end{matrix} ) \qquad ( 4 )$$

In the equation (4), a matrix A is a characteristic matrix. In this manner, the equation (4) shows the relation between the three images and the incident rays having a resolution three times higher than that of the imaging device 15. Similarly, as shown in the equation (4), in a case where the relation between N images (N is an integer equal to or higher than 2) and incident rays whose resolution is N times higher than that of the imaging device 15 is known, if the inverse matrix of the characteristic matrix is obtained, the incident rays can be estimated by multiplying output signals by the inverse matrix, whereby images having a resolution N times higher than that of the imaging device 15 can be obtained.

The pseudo hand-shake signal adder 12 changes the displacement as shown in FIGS. 2A and 2B, whereby the relation expressed by the equation (4) can be obtained. The image synthesis section 18 estimates, using the equation (4), pixel values based on an image taken at one time, a later image taken after the pseudo hand-shake signal adder 12 changes the displacement, and a displacement of the latter image with respect to the former image, so as to estimate an image that has a higher number of pixels than those images, and outputs the estimated image to the still image record and transmission section 2.

The still image record and transmission section 2 transmits the image estimated by the image synthesis section 18 into the image display apparatuses 30 and 40. The still image record and transmission section 2 may write the output of the image synthesis section 18 to a memory card or the like and read data from the memory card or the like to output the read data to the image display apparatuses 30 and 40.

As described above, in the imaging apparatus 10 of FIG. 1, an incident image is displaced according to a certain pattern, whereby it is possible to take a high-definition still image that has a higher number of pixels than an image originally obtainable by the imaging device 15.

In cases where a sufficient number of images can be taken, the image synthesis section 18 performs image estimation by a least-squares method using the following equation (5).

$$( \begin{matrix}i 0 \\ i 1 \\ i 2 \\ i 3 \\ i 4 \\ i 5 \\ i 6 \\ i 7\end{matrix} ) = {( {A}^{T} A )}^{- 1} {A}^{T} ( \begin{matrix}o 00 \\ o 01 \\ o 02 \\ o 10 \\ o 11 \\ o 12\end{matrix} ) \qquad ( 5 )$$

Then, the estimation accuracy is increased. When an image is estimated based on N images taken, the number of pixels of the estimated image can be N times higher than that of the taken images. Even in cases where the number of taken images is limited to less than N, the estimation by a least-squares method is possible. In this manner, the high-resolution image estimated by the image synthesis section 18 and having a higher number of pixels can be recorded or transmitted.

If any change occurs in an image when the image is being taken, the obtained image is blurred. In order to reduce such blurring caused by the temporal change of the object, the image synthesis section 18 may be designed so that it detects a region in the image in which a change has occurred, and does not carry out the aforementioned high-resolution image estimation for that region. Then, the image synthesis section 18 may select one image from the taken images and combine the selected image with the other region for which the aforementioned high-resolution image estimation has been performed.

In some cases, such as when an image of a distant object is taken using a telephoto lens, the accuracy of the hand-shake sensor 11 and the accuracy of the displacement added by the pseudo hand-shake signal adder 12 may be insufficient. In such cases, the imaging apparatus 20 of FIG. 1 estimates a shift of images from the images themselves. The imaging apparatus 20 includes an imaging device 25, a correction section 26, a shift-amount detection section 27, and an image synthesis section 28.

The imaging device 25 is similar to the imaging device 15. The imaging device 25 first takes a first image serving as a reference, and then takes a second image after an incident image on the imaging device 25 is shifted due to movement of the imaging device 25 or the like. The imaging device 25 repeatedly takes a second image each time the incident image is shifted.

The shift-amount detection section 27 shifts each of the second images and/or the reference first image so that an error (the square value of the difference, etc.) between each second image and the reference first image can be minimized, thereby detecting the displacement of each second image with respect to the reference first image. The shift-amount detection section 27 divides the detected displacement of each second image into a pixel-unit displacement and the remaining less-than-single-pixel displacement and outputs the pixel-unit displacement and the less-than-single-pixel displacement to the correction section 26 and the image synthesis section 28, respectively.

The correction section 26 shifts each second image in the direction opposite to the direction of the pixel-unit displacement of that image to the same extent as the pixel-unit displacement so that the detected displacement of the second image is cancelled, and outputs the obtained image to the image synthesis section 28. The image synthesis section 28 estimates pixel values, by using the equation (4), in accordance with the first image, the shifted second images, and the less-than-single-pixel displacements, so as to estimate the pixels of a third image that has a higher number of pixels than the first image and the shifted second images. The image synthesis section 28 then outputs the obtained high-resolution third image to the still image record and transmission section 2. The image synthesis section 28 may alternatively perform the image estimation by a least-squares method using the equation (5).

The image synthesis section 28 may perform the aforementioned high-resolution image estimation for regions in the obtained image in which the error therein is smaller than a threshold value supplied beforehand, and for each of regions having an error equal to or greater than the threshold value, select one image from the taken images, and then combine the images in the respective regions together.

Alternatively, the image synthesis section 28 may be designed as follows. For each of the regions in the image in which temporal change has occurred and the error therein is equal to or greater than the threshold value, the image synthesis section 28 may select from the plurality of images an image that makes the error in that region be smaller than the threshold value, and then may perform the aforementioned high-resolution image estimation using the selected images.

Also, for the regions having an error equal to or greater than the threshold value, the image synthesis section 28 may use a specific pixel value called a blue back color or a chroma key color, which is not contained in the still image. In that case, a dynamic image encoded according to the MPEG (moving picture experts group) standard or the like is recorded or transmitted separately from the high-resolution still image, and decoded and displayed in the blue-back-color or chroma-key-color regions.

Now, a description will be made of high-resolution display using a display device which has a smaller number of pixels than a recorded or transmitted high-resolution image. In FIG. 1, the image display apparatus 30 includes a hand-shake sensor 31, a hand-shake correction section 32, an image memory 34, an image-size reduction interpolation section 35, a read position control section 36, and a display device 37. In this embodiment, it is assumed that when the image display apparatus 30 is used, it is not fixed, for example, it is hand-held.

The hand-shake sensor 31 senses acceleration, angular acceleration, and the like given to the display device 37 by hand-shake, obtains a displacement of the display device 37 caused by the hand-shake, and outputs the obtained displacement to the hand-shake correction section 32. The hand-shake correction section 32 divides the displacement of the display device 37 into a pixel-unit displacement of the display device 37 and the remaining less-than-single-pixel displacement and outputs the pixel-unit displacement and the less-than-single-pixel displacement to the read position control section 36 and the image-size reduction interpolation section 35, respectively. The image memory 34 stores image data transmitted or the like and outputs the stored data to the image-size reduction interpolation section 35.

The image-size reduction interpolation section 35 reduces the size of the image read from the image memory 34 so that the image can be displayed on the display device 37, while the image-size reduction interpolation section 35 obtains the value of each pixel by linear interpolation so that the size-reduced image is shifted in the direction opposite to the less-than-single-pixel displacement of the display device 37 to the same extent as the less-than-single-pixel displacement. The read position control section 36 reads the image data from the image-size reduction interpolation section 35 and outputs the read data to the display device 37 so that the image obtained by the image-size reduction interpolation section 35 is shifted in the direction opposite to the pixel-unit displacement to the same extent as the pixel-unit displacement.

As a result, the image displayed on the display device 37 is recognized as a high-resolution image interpolated at the subpixel positions. For example, even for a characters- and graphics-containing website image transmitted via the Internet, an interpolated image can be displayed likewise by storing a high-resolution website image in the image memory 34.

The image-size reduction interpolation section 35 may shift the image by the amount of displacement obtained by multiplying the less-than-single-pixel displacement by a predetermined value, and the read position control section 36 may shift the image by the amount of displacement obtained by multiplying the pixel-unit displacement by a predetermined value.

In the foregoing, the case in which the display device is directly seen has been described. However, in cases where the display device is seen through an optical system or in cases where a display image is projected, the display can be performed in a similar way. As an example, a case in which the liquid crystal projector 40 of FIG. 1 is used as an image display apparatus will be described. The liquid crystal projector 40 of FIG. 1 includes a pseudo hand-shake generator 42, an image memory 44, an image-size reduction interpolation section 45, a display device 47, and an optical correction section 48. An output image OP is projected onto a screen or the like.

The pseudo hand-shake generator 42 generates a signal for instructing that a region in the screen or the like onto which an image can be projected (an image projectable region) be shifted by subpixel units, and outputs the signal to the image-size reduction interpolation section 45 and the optical correction section 48. The pseudo hand-shake generator 42 shifts the image projectable region by subpixel units according to the pattern shown in FIG. 2A or 2B, for example.

Each time the image projectable region is shifted, the image-size reduction interpolation section 45, like the image-size reduction interpolation section 35, obtains the values of the pixels of the image shifted in the direction opposite to the displacement to the same extent as the displacement. The display device 47 displays the obtained pixels and projects the displayed image through the optical correction section 48. The optical correction section 48 controls the direction in which the output image OP is projected, in accordance with the signal from the pseudo hand-shake generator 42.

As described above, since the liquid crystal projector 40 shifts the positions of the projected pixels by subpixel units, high-resolution image display by a projection-type image display apparatus can be performed.

Now, a description will be made of a liquid crystal projector (not shown) obtained by replacing, in the liquid crystal projector 40, the pseudo hand-shake generator 42 with a hand-shake sensor and a hand-shake correction section. It is assumed that when this liquid crystal projector is used, it is not fixed, for example, it is hand-held. The hand-shake sensor senses movement of the liquid crystal projector caused by hand-shake, obtains a displacement of a region onto which an image can be projected, and outputs the obtained displacement to the hand-shake correction section. The hand-shake correction section divides the displacement of the image-projectable region into a pixel-unit displacement of the image and the remaining less-than-single-pixel displacement, and outputs the pixel-unit displacement and the less-than-single-pixel displacement to the optical correction section and the image-size reduction interpolation section, respectively.

Each time the image projectable region is shifted, the image-size reduction interpolation section, like the image-size reduction interpolation section 35, obtains the values of the pixels of the image shifted in the direction opposite to the less-than-single-pixel displacement to the same extent as the less-than-single-pixel displacement and outputs the obtained pixel values to the display device. The display device displays the obtained image. The optical correction section controls the direction in which the output image OP is projected, so that the output image OP is shifted in the direction opposite to the pixel-unit displacement to the same extent as the pixel-unit displacement.

This liquid crystal projector, like the image display apparatus 30, can display an image so that the image is recognized as a high-resolution image having a resolution higher than that of the display device.

### SECOND EMBODIMENT

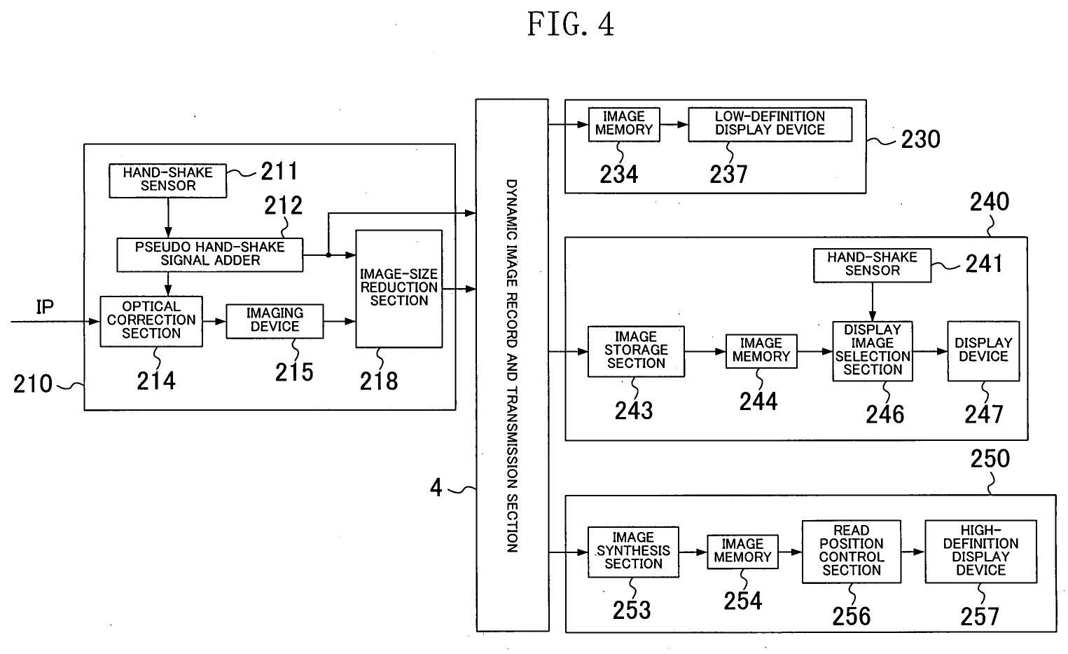

FIG. 4 is a block diagram of an image taking and display system according to a second embodiment of the present invention. The image taking and display system of FIG. 4 includes an imaging apparatus 210, image display apparatuses 230, 240, and 250, and a dynamic image record and transmission section 4. The imaging apparatus 210 and the image display apparatuses 230, 240, and 250 are each capable of operating independently.

The imaging apparatus 210 includes a hand-shake sensor 211, a pseudo hand-shake signal adder 212, an optical correction section 214, an imaging device 215, and an image-size reduction section 218. The hand-shake sensor 211, the pseudo hand-shake signal adder 212, and the optical correction section 214 are the same as the hand-shake sensor 11, the pseudo hand-shake signal adder 12, and the optical correction section 14 of FIG. 1, respectively. The pseudo hand-shake signal adder 212 outputs a displacement based on a certain pattern to the dynamic image record and transmission section 4.

The imaging device 215 takes a dynamic image and outputs the dynamic image to the image-size reduction section 218. The image-size reduction section 218 reduces the size of the input image as necessary and outputs the size-reduced image to the dynamic image record and transmission section 4. For example, when the number of pixels of the display device 237 is smaller than that of the imaging device 215, the image-size reduction section 218 reduces the size of the input image. The dynamic image record and transmission section 4 transmits the output of the image-size reduction section 218 and the displacement based on the certain pattern to the image display apparatuses 230, 240, and 250. The dynamic image record and transmission section 4 may write the output of the image-size reduction section 218 and the output of the hand-shake signal adder 212 into a memory card or the like and read data from the memory card or the like to output the read data to the image display apparatuses 230, 240, and 250.

The image display apparatus 230 includes an image memory 234 and a low-definition display device 237. The image memory 234 stores image data transmitted or read by the dynamic image record and transmission section 4 and outputs the stored data to the low-definition display device 237. The low-definition display device 237 displays an image which has the same number of pixels as the imaging device 215 and is output from the image memory 234, for example.

When the low-definition display device 237 displays a series of images obtained by less-than-pixel-size shifting of the imaging device 215, the person who sees these images estimates pixel values at inter-pixel positions in the imaging device 215 and therefore recognizes these images as high-resolution images having a higher resolution than that of the imaging device 215. As a result, it is possible to record or transmit the dynamic images with a natural hand-shake, which are recognized as images having a higher resolution than the imaging device 215 and the display device 237.

Alternatively, while a series of still images are taken with a displacement based on a certain pattern being provided, these images may be recorded or transmitted as dynamic images. In that case, the effect that the images are recognized as high-resolution images is also obtained as in the case of the dynamic images. The image display apparatus 240 used in such a case will be described. The image display apparatus 240 includes a hand-shake sensor 241, an image storage section 243, an image memory 244, a display image selection section 246, and a display device 247. It is assumed that the image display apparatus 240 is portable.

In the imaging apparatus 210, the pseudo hand-shake signal adder 212 generates a signal for providing a displacement based on a certain pattern, and the imaging device 215 takes a series of still images corresponding to this signal as dynamic images. The imaging apparatus 210 makes the dynamic image record and transmission section 4 record or transmit the displacement-providing signal and the series of taken still images. The image storage section 243 stores the read or transmitted displacement-providing signal and data on the series of still images and makes the image memory 244 store part of the stored data. Each of the still images and the displacement-providing signal used in taking that still images are associated with each other when they are stored.

The hand-shake sensor 241 senses a displacement of the display device 247 caused by shifting of the display device 247 and outputs the sensed displacement to the display image selection section 246. The display image selection section 246 selects, based on the read or transmitted displacement-providing signal, an image from the images stored in the image memory 244 which corresponds to an image obtained by shifting the image displayed before the shifting of the display device 247, in the direction opposite to the displacement of the display device 247 to the same extent as the displacement, and outputs the selected image to the display device 247. The display device 247 displays the selected image.

In this manner, the image display apparatus 240, like the image display apparatus 30 of FIG. 1, allows an image to be recognized as a high-resolution image that has a higher number of pixels than the display device. In the image display apparatus 240, image interpolation is not necessary to achieve this.

When the respective numbers of pixels of the display devices 237 and 247 are lower than that of the imaging device 215, images are reduced in size by the image-size reduction section 218 so as to be suited for the display device having the lowest number of pixels, and then recorded or transmitted. At this time, the image-size reduction section 218 also reduces the amount of displacement corresponding to each image. The display image selection section 246 make a selection from the plurality of size-reduced images. In this case, a dynamic image record and transmission section having a smaller recording capacity and a lower transmission rate may be used as the dynamic image record and transmission section 4. Also, when the dynamic image record and transmission section 4 has a limited recording capacity or a limited transmission rate, the image-size reduction section 218 may reduce the size of images in accordance with those limitations.

Next, a description will be made of the image display apparatus 250. The image display apparatus 250 includes an image synthesis section 253, an image memory 254, a read position control section 256, and a high-definition display device 257. It is assumed that the resolution of images taken by the imaging apparatus 210 for recording or transmission is lower than that of the high-definition display device 257. It is also assumed that the high-definition display device 257 cannot be moved. In this case, it is necessary to combine recorded or transmitted images together to obtain a high-resolution image.

In FIG. 4, the image synthesis section 253 combines transmitted or read image data into a higher resolution dynamic image by using a displacement-providing signal transmitted or read by the dynamic image record and transmission section 4, with the displacement-providing signal providing a displacement based on a certain pattern. The image synthesis section 253 then outputs the dynamic image to the image memory 254. In this process, the image synthesis section 253, like the image synthesis section 18 of FIG. 1, estimates pixel values so as to estimate the high-resolution image. The transmitted or read image data may be data on images whose size has been reduced by the image-size reduction section 218 or may be data on images whose size has not been reduced.

The read position control section 256 reads data from the image memory 254 and outputs the read data to the high-definition display device 257. If the image is shifted more than a single pixel, the read position control section 256 changes the address for reading data from the image memory 254 and performs correction by pixel units so that the displacement according to the supplied certain pattern can be canceled. The high-definition display device 257 displays the image output from the image memory 254.

In this manner, the image display apparatus 250 can display an image which has a higher resolution than the received image.

The image synthesis section 253 may be designed so that it determines a region in each image in which change is small as a still image region, detects subpixel-unit shifting of this region of each image as the displacement of that image, and estimates pixel values of a high-resolution image so as to synthesize the high-resolution image.

As described above, in the image taking and display system of FIG. 4, the imaging apparatus reduces the size of images so that the images are suited for one of the different types of usable image display apparatuses that has the lowest number of pixels, and each image display apparatus that receives the obtained image data can estimate an image having a higher resolution than the received image data, in accordance with the displayable resolution of that apparatus and display the high-resolution image. Also, even in cases where the image-data recording capability or the image-data transmission rate is limited, images can be reduced in size in accordance with these limitations and then recorded or transmitted, and the image display apparatuses that receive the image data can synthesize and display a high-resolution image.

A signal for providing a displacement based on a certain pattern may be multiplexed into an MPEG stream as a PAN signal or a SCAN signal based on the MPEG standard, before it is recorded or transmitted.

Although in the foregoing embodiments the one-dimensional pixel estimation has been described, two-dimensional estimation can also be performed easily.

As described above, the present invention improves the quality of images which are taken or displayed and is thus effectively applied to apparatuses for taking or displaying images, and the like.

What is claimed is:

1. A method for displaying an image comprising:
the step of detecting a displacement of a display device; and
the step of shifting an image on the display device by subpixel units in a direction opposite to the displacement of the display device to an extent corresponding to the displacement of the display device and displaying the shifted image.

2. The method of claim 1, wherein the image display step includes:
the sub-step of dividing the displacement of the display device into a pixel-unit displacement and a remaining less-than-single-pixel displacement;
the sub-step of obtaining, by interpolation, an image shifted on the display device to an extent corresponding to the less-than-single-pixel displacement; and
the sub-step of shifting the image obtained by the interpolation to an extent corresponding to the pixel-unit displacement.

3. A method for displaying an image by a projection-type image display apparatus, the method comprising:
the step of shifting a region onto which an image can be projected by subpixel units according to a certain pattern;
the step of obtaining an image by interpolation each time the region is shifted, so that the image is shifted in a direction opposite to a displacement of the region to an extent corresponding to the displacement; and
the step of projecting the obtained image.

4. A method for displaying an image by a projection-type image display apparatus, the method comprising:
the step of detecting a displacement of a region onto which an image can be projected, in accordance with movement of the image display apparatus; and
the step of shifting by subpixel units the image projected onto the region, in a direction opposite to the displacement of the region to an extent corresponding to the displacement of the region and displaying the shifted image.

5. A method for displaying an image comprising:
the step of taking a plurality of images with an incident image on an imaging device being shifted by subpixel units according to a certain pattern;
the step of detecting a displacement of a display device; and
the step of selecting, from the plurality of images, an image which is obtained by shifting an image on the display device in a direction opposite to the displacement of the display device to an extent corresponding to the displacement of the display device and displaying the selected image.

6. The method of claim 5, further comprising the step of reducing the size of the plurality of images and respective displacements of the plurality of images,
wherein in the image selection and display step, an image is selected from the plurality of size-reduced images in accordance with the displacement of each of the size-reduced images.

7. A method for displaying an image comprising:
the step of taking a plurality of images with an incident image on an imaging device being shifted by subpixel units according to a certain pattern; and
the step of estimating pixel values based on the plurality of images and respective displacements of the plurality of images, estimating based on the estimated pixel values an image which has a higher number of pixels than the plurality of images, and displaying the estimated image.

8. The method of claim 7, further comprising the step of reducing the size of the plurality of images and the respective displacements of the plurality of images,
wherein in the image estimation and display step, an image which has a higher number of pixels than the plurality of size-reduced images is estimated based on the plurality of size-reduced images and the displacement of each of the size-reduced images, and the estimated image is displayed.

9. The method of claim 7, further comprising the step of transmitting information on the certain pattern,
wherein in the image estimation and display step, the transmitted information on the certain pattern is used as the displacements of the plurality of images.

10. The method of claim 7, wherein in the image estimation and display step, the respective displacements of the plurality of images are obtained based on the plurality of images themselves.

11. A method for taking an image comprising:
the step of taking a first image by an imaging device;
the step of shifting an incident image on the imaging device by subpixel units according to a certain pattern;
the step of taking the shifted incident image as a second image; and
the step of estimating pixel values based on the first and second images and a displacement of the second image with respect to the first image, thereby estimating a third image which has a higher number of pixels than the first and second images.

12. The method of claim 11, wherein the incident image shifting step and the step of taking the shifted incident image as a second image are repeated; and
in the third image estimation step, the estimation is performed based on the first image and the plurality of second images.

13. The method of claim 11, wherein in the third image estimation step, the image estimation is performed using a least-squares method.

14. A method for taking an image comprising:
the step of taking a first image by an imaging device;
the step of taking a second image after an incident image on the imaging device is shifted;
the step of detecting a displacement of the second image with respect to the first image,
the step of dividing the displacement of the second image into a pixel-unit displacement and a remaining less-than-single-pixel displacement;
the step of shifting the second image in a direction opposite to the pixel-unit displacement to an extent equal to the pixel-unit displacement; and
the step of estimating pixel values based on the first image, the shifted second image, and the less-than-single-pixel displacement, thereby estimating a third image which has a higher number of pixels than the first image and the shifted second image.

15. The method of claim 14, wherein the second image taking step is repeated; and
in the third image estimation step, the estimation is performed based on the first image and the plurality of second images.

16. The method of claim 14, wherein in the third image estimation step, the image estimation is performed using a least-squares method.

17. A method for taking an image comprising:
the step of detecting movement of an imaging device;
the step of adding movement of a certain pattern to the movement of the imaging device;
the step of displacing an incident image on the imaging device so that an effect produced by the movement obtained by the addition is canceled; and
the step of taking the incident image.

18. The method of claim 17, further comprising the step of selecting one pattern from a plurality of certain patterns,
wherein in the step of adding movement of a certain pattern, the movement is added in accordance with the selected pattern.

19. A method for synthesizing an image comprising:
the step of dividing a displacement of a second image with respect to a first image into a pixel-unit displacement and a remaining less-than-single-pixel displacement;
the step of shifting the second image in a direction opposite to the pixel-unit displacement to an extent equal to the pixel-unit displacement; and
the step of estimating pixel values based on the first image, the shifted second image, and the less-than-single-pixel displacement, thereby estimating a third image which has a higher number of pixels than the first image and the shifted second image.

20. The method of claim 19, further comprising the step of detecting the displacement of the second image with respect to the first image.

21. The method of claim 19, wherein a plurality of images are each used as the second image; and
in the third image estimation step, the estimation is performed based on the first image and the plurality of second images.

22. The method of claim 19, wherein in the third image estimation step, the image estimation is performed using a least-squares method.
